(19) United States
(12) Patent Application Publication
(10) Pub. No.: US 2016/0370590 A1
(43) Pub. Date: Dec. 22, 2016

(54) IMAGE DISPLAY DEVICE

(71) Applicant: SEIKO EPSON CORPORATION, Tokyo (JP)

(72) Inventor: Takeshi FUJISHIRO, Shiojiri-shi (JP)

(73) Assignee: SEIKO EPSON CORPORATION, Tokyo (JP)

(21) Appl. No.: 15/174,277

(22) Filed: Jun. 6, 2016

(30) Foreign Application Priority Data
Jun. 19, 2015 (JP) 2015-123642

(51) Int. Cl. G02B 27/01

(52) U.S. Cl. CPC G02B 27/0176; G02B 2027/0154

(57) ABSTRACT

An image display device includes a device main body which is mounted on the head of a user and a mounting member that mounts the device main body on the head. The device main body includes a frame that comes into contact with the forehead in the head and a display portion, provided in the frame, which displays an image. The mounting member, formed of a material having a predetermined hardness, which comes into contact with a contact region which is set in a lower portion in the occipital region of the head and holds the head together with the frame.

### BACKGROUND

1. Technical Field

The present invention relates to an image display device.

2. Related Art

Hitherto, a virtual image display device such as a head mounted display (HMD) which is mounted on the head of a user has been known (see, for example, JP-A-2014-186201).

The virtual image display device disclosed in JP-A-2014-186201 includes a first image forming main body and a second image forming main body which are provided on the right and left sides of a user, respectively, and light guide members that guide image light which is formed by these image forming main bodies to the right eye and the left eye of the user, respectively, and is configured as a see-through HMD. Besides, the virtual image display device includes a frame portion provided with a nose pad member which is brought into contact with the nose of the user and temple portions, provided in the frame portion, which are brought into contact with the vicinity of the temples of the user. The virtual image display device is mounted so that each light guide member is disposed in front of the eyes of the user by disposing the respective temple portions at positions corresponding to the right and left temples and touching the nose pad member to the nose.

However, in the virtual image display device disclosed in JP-A-2014-186201, the virtual image display device is supported by the temple portions and the nose pad member, and thus there is a problem in that mountability and a mounting feeling are not high. Particularly, in a case where the user carrying out a predetermined work makes use of the virtual image display device, there may be a concern of a displayed image not being appropriately visually recognized due to a slipping or the like of the virtual image display device while at work.

### SUMMARY

An advantage of some aspects of the invention is to provide an image display device having high mountability.

An image display device according to an aspect of the invention includes: a display portion that displays an image so as to be capable of being observed by a user; a frame that comes into contact with the forehead in the head of the user; and a mounting member, formed of a material having a predetermined hardness, which comes into contact with a contact region which is set in a lower portion in the occipital region of the head and holds the head together with the frame.

Meanwhile, the lower portion in the occipital region indicates a region from a region protruding most backward up to the nape of the neck in the occipital region, and can include, for example, a region including the external occipital protuberance.

According to the aspect, the head of the user is held by the frame coming into contact with the forehead and the mounting member coming into contact with the contact region which is set in the lower portion in the occipital region, and thus the image display device is mounted. According to this, it is possible to hold the head at positions located on opposite sides of each other in the head. Therefore, it is possible to stably mount the image display device on the head of the user, as compared to a configuration in which the virtual image display device disclosed in the JP-A-2014-186201 is mounted so as to be placed on the ears and the nose by the temple portions and the nose pad member. Therefore, it is possible to form an image display device having high mountability.

In the image display device according to the aspect, it is preferable that the mounting member is connected to the frame so as to be rotatable about a rotating shaft parallel to a lineup direction of both eyes of the user.

According to this configuration, the mounting member is made vertically rotatable about the rotating shaft. According to this, it is possible to change the position of the mounting member so that a portion of the contact member comes into contact with the contact region, in accordance with the size or shape of the head of the user. Therefore, it is possible to mount the image display device at an appropriate position, and to further improve the mountability of the image display device.

In the image display device according to the aspect, it is preferable that the frame is formed in an arc shape conforming to a shape of the head, the rotating shaft includes a first rotating shaft and a second rotating shaft to which the mounting member is rotatably connected, and the first rotating shaft and the second rotating shaft are located on one end side and the other end side having the arc shape in the frame, and on a surface facing the head.

Here, in a case where the mounting member is installed in the vicinity of the center of the frame, the mounting member formed of a material having a predetermined hardness is not likely to bend, and the mounting member is not likely to be laid along the head. In addition, even in a case where the mounting member is installed on the opposite side to the side facing the head in the frame, the mounting member is not likely to be laid along the head.

On the other hand, according to the above configuration, since the mounting member is installed in the vicinity of both ends having an arc shape in the frame, it is possible to easily bend the mounting member, and to easily lay the mounting member along the head. Besides, since the mounting member is connected to a surface on the side facing the head in the frame, it is possible to easily lay the mounting member along the head. Therefore, it is possible to further improve the mountability of the image display device.

In the image display device according to the aspect, it is preferable to further include a support member, rotatably installed on the frame, which supports the display portion.

According to this configuration, by rotating the support member, it is possible to locate the display portion at a position appropriate to the user, and to locate the display portion outside of the visual field of the user. Therefore, it is possible to locate the display portion at a desired position of the user.

In the image display device according to the aspect, it is preferable that the support member includes a pair of arms which are rotatably connected to a shaft provided on in the vicinity of both ends of the arc shape in the frame, a rotating shaft of one arm out of the pair of arms is located coaxially with one rotating shaft out of the first rotating shaft and the second rotating shaft, and a rotating shaft of the other arm is located coaxially with the other rotating shaft out of the first rotating shaft and the second rotating shaft.

According to this configuration, the shaft serving as the rotating shaft of each arm in the frame can be used as a shaft for rotatably installing the mounting member. For this reason, it is not necessary to separately provide a shaft for installing the mounting member. Therefore, it is possible to prevent the configurations of the frame and the image display device from being complicated.

In the image display device according to the aspect, it is preferable that the frame is formed in an arc shape conforming to a shape of the head, and the mounting member includes a pair of first extending portions, connected to the frame, which extend out along an arc-shaped extended line of the frame, a pair of second extending portions that extend out downward from the pair of first extending portions, respectively, and a contact portion that extends out from each of the pair of second extending portions in parallel with an extending direction of the pair of first extending portions, and comes into contact with the contact region.

Here, the ears are located on a line that links the contact region to the forehead, depending on the position of the contact region. In this case, when the ears are covered with the mounting member, a burden on a user increases, and thus it is not likely that the image display device is mounted for a long period of time.

On the other hand, according to the above configuration, the ears are not covered with the mounting member, and thus it is possible to bring the contact portion into contact with the contact region. Therefore, it is possible to suppress an increase in a burden on a user due to the mounting of the image display device.

In the image display device according to the aspect, it is preferable that the contact portion is larger in vertical dimension than each of the pair of first extending portions and each of the pair of second extending portions.

Meanwhile, the vertical direction as used herein refers to is a direction that links the jaw to the top of the head of the user.

According to the aspect with this configuration, the mounting member is formed so that a portion laid along the temporal region is small in vertical dimension, and that a portion coming into contact with the contact region is large in vertical dimension. According to this, since the flexibility of the portion laid along the temporal region can be secured, it is possible to easily lay the mounting member along the temporal region. In addition, since the area of contact with the contact region can be made larger, it is possible to stably bring the contact portion into contact with the contact region. Therefore, it is possible to further improve the mountability of the image display device.

In the image display device according to the aspect, it is preferable that the mounting member includes a regulation mechanism capable of regulating a length of the mounting member.

According to this configuration, since the length dimension of the mounting member can be adjusted in accordance with the shape and size of the head of a user, each user can appropriately wear the image display device.

In the image display device according to the aspect, it is preferable that the mounting member includes a first band including one first extending portion out of the pair of first extending portions, one second extending portion out of the pair of second extending portions which is connected to the one first extending portion, and a portion of the contact portion, and a second band including the other first extending portion out of the pair of first extending portions, the other second extending portion out of the pair of second extending portions, and another portion of the contact portion, the regulation mechanism is provided in the one band so as to be capable of sliding one band out of the first band and the second band relatively to the other band, and the regulation mechanism includes a locking portion that locks one band out of the first band and the second band with respect to the other band, and a release portion that releases a locked state of the one band by the locking portion.

According to this configuration, one band out of the first band and the second band is moved relatively to the other band, and then the other band is locked by the regulation mechanism, thereby allowing the adjusted length of the mounting member to be maintained. In addition, since the locked state by the locking portion can be released by the release portion, it is possible to extend the mounting member to such an extent that the image display device can be detached from the head. Therefore, it is possible to reliably perform the attachment and detachment of the image display device to and from the head.

In the image display device according to the aspect, it is preferable that the regulation mechanism includes a regulation portion that regulates falling off of one of the first band and the second band from the other band.

According to this configuration, the regulation portion regulates the falling off of one of the first band and the second band from the other band. Thus, it is possible to reliably prevent the image display device from falling off from the head due to the one band falling off unintentionally, when the locked state by the locking portion is released.

In the image display device according to the aspect, it is preferable that the frame includes a cable extending out from the frame to an outside, and the regulation mechanism includes a holding portion that holds the cable.

According to this configuration, even when a user carries out a predetermined work after wearing the image display device, it is possible to suppress a fluctuation of the cable extending out from the frame. Therefore, it is possible to improve the convenience of the image display device.

In the image display device according to the aspect, it is preferable that the frame includes an elastic member, provided in the frame, which comes into contact with the forehead.

According to this configuration, by the elastic member being elastically deformed, it is possible to make the mounting feeling of the image display device satisfactory, as compared to a case where a relatively solid portion in the frame comes into direct contact with the forehead. In addition, it is possible to hold the head while applying an appropriate pressure to the head through the elastic member and the mounting member which are elastically deformed during the mounting of the image display device. Therefore, it is possible to further improve the mountability of the image display device.

In the image display device according to the aspect, it is preferable that the elastic member is formed to be hollow.

According to the configuration, it is possible to facilitate the elastic deformation of the elastic member coming into contact with the forehead during the mounting of the image display device on the head. Therefore, it is possible to still further improve the mountability of the image display device.

### BRIEF DESCRIPTION OF THE DRAWINGS

The invention will be described with reference to the accompanying drawings, wherein like numbers reference like elements.

FIG. 1 is a perspective view illustrating an image display device according to an embodiment of the invention.

FIG. 2 is a side view illustrating the image display device mounted on a user wearing a cap in the embodiment.

FIG. 3 is a perspective view when the image display device in the embodiment is seen from the left front side.

FIG. 4 is a perspective view when the image display device in the embodiment is seen from the right back side.

FIG. 5 is a right side view illustrating the image display device in the embodiment.

FIG. 6 is a perspective view when a head band portion in the embodiment is seen from the back side.

FIG. 7 is a perspective view illustrating a pad in the embodiment.

FIG. 8 is a diagram illustrating an arrangement position of a light guide member with respect to the line of sight in the embodiment.

FIG. 9 is a plan view illustrating a display portion in the embodiment.

FIG. 10 is a perspective view illustrating the image display device having a cover member removed therefrom in the embodiment.

FIG. 11 is a perspective view illustrating the cover member in the embodiment.

FIG. 12 is a perspective view illustrating the image display device from which a lens holder is removed in the embodiment.

FIG. 13 is a perspective view when the image display device in the embodiment is seen from the back side.

FIG. 14 is an exploded perspective view illustrating a mounting band in the embodiment.

FIG. 15 is an exploded perspective view illustrating the mounting band in the embodiment.

FIG. 16 is a plan view in which the configuration of the mounting band in the embodiment is divided.

FIG. 17 is a perspective view illustrating a state of engagement of a support member, a first band and a second band of the mounting band in the embodiment.

### DESCRIPTION OF EXEMPLARY EMBODIMENTS

Hereinafter, an embodiment of the invention will be described with reference to the accompanying drawings.

### Schematic Configuration of Image Display Device

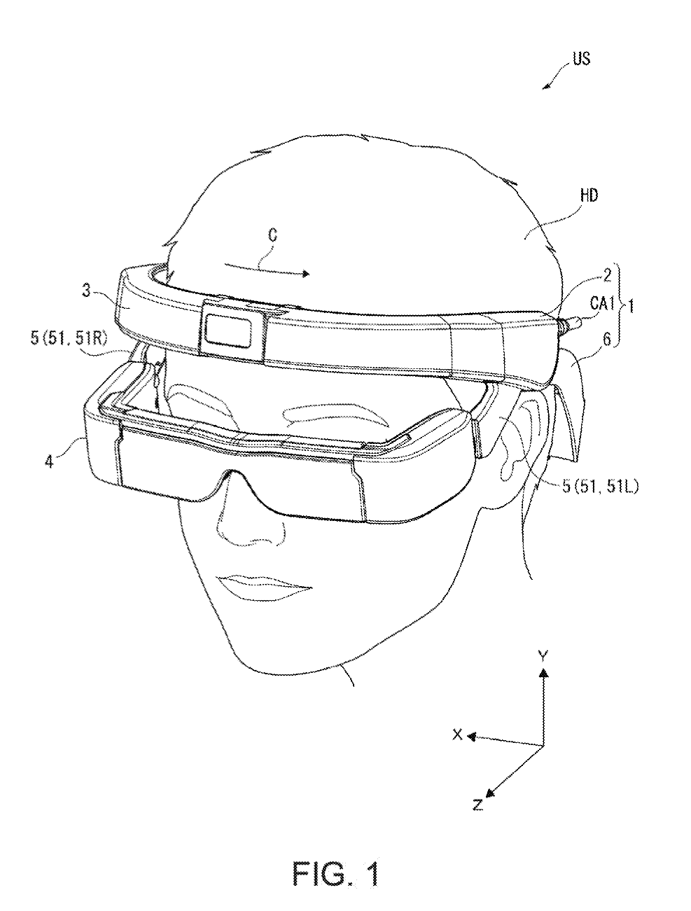

FIG. 1 is a perspective view illustrating an image display device 1 according to the present embodiment. Specifically, FIG. 1 is a perspective view illustrating the image display device 1 which is directly mounted on a head HD of a user US.

As shown in FIG. 1, the image display device 1 according to the present embodiment is a head mounted image display device (HMD), mounted on the head HD of the user US, which causes image light to be incident on the eyes of the user US to thereby visually recognize an image which is formed by the image light. This image display device 1 is configured as a see-through HMD, and is configured to be capable of observing the external field in addition to being capable of visually recognizing the image as a virtual image.

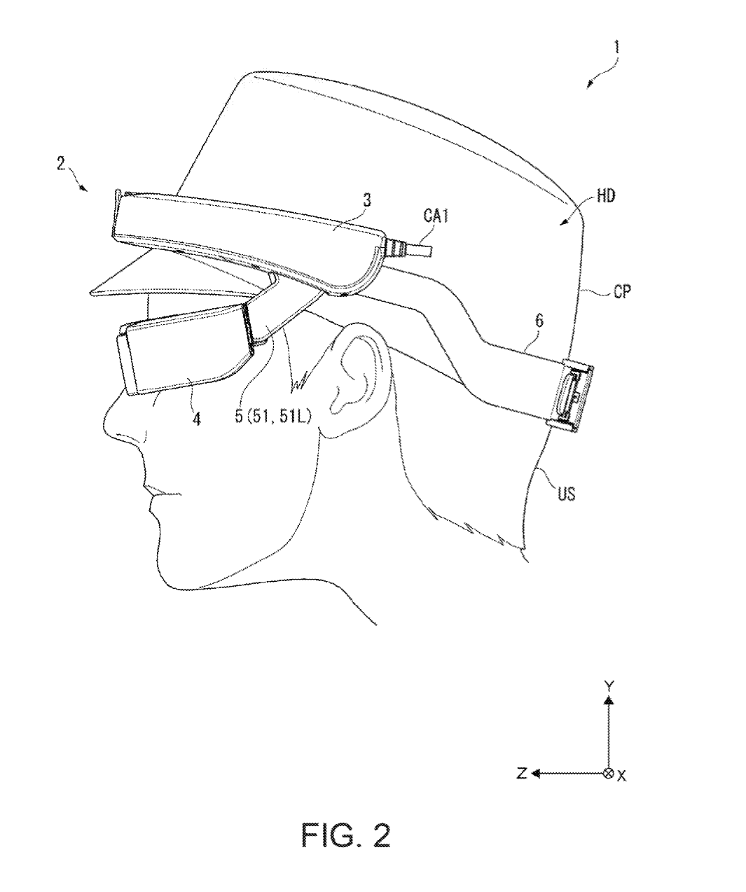

FIG. 2 is a side view illustrating the image display device 1 mounted on the head HD of the user US wearing a cap CP.

Meanwhile, the image display device 1 can be directly mounted on the head HD of the user US, and can also be indirectly mounted on the head HD through the cap CP, a helmet or the like, as shown in FIG. 2. Therefore, in the following description, the head HD includes not only a case of directly indicating the head HD, but also a case of indicating a head HD on which the cap CP, a helmet or the like is mounted.

In addition, in the following description, a Z-direction is a direction toward the outer side of the head HD through the center between both eyes, among directions orthogonal to the axial direction of the head HD of the user US having the image display device 1 mounted thereon. An X-direction and a Y-direction are directions which are orthogonal to the Z-direction and are orthogonal to each other. Among these directions, the Y-direction is a direction from the jaw side toward the top of the head side along the axial direction of the head HD, and the X-direction is a direction from the left side toward the right side when seen from the user US. A direction C is an anticlockwise direction when seen from the Y-direction side in circumferential directions centering around the axial direction of the head HD.

Further, the Z-direction side indicates a downstream side (Z-direction tip side) in the Z-direction, and the opposite side to the Z-direction side indicates an upstream side (Z-direction base side) in the Z-direction. The same is true of other directions.

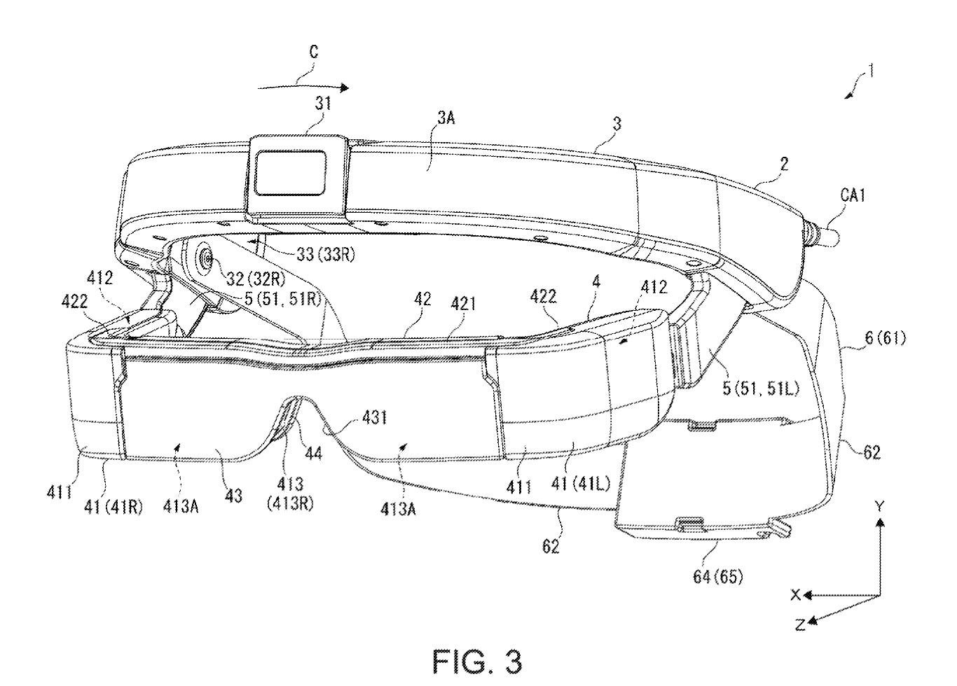

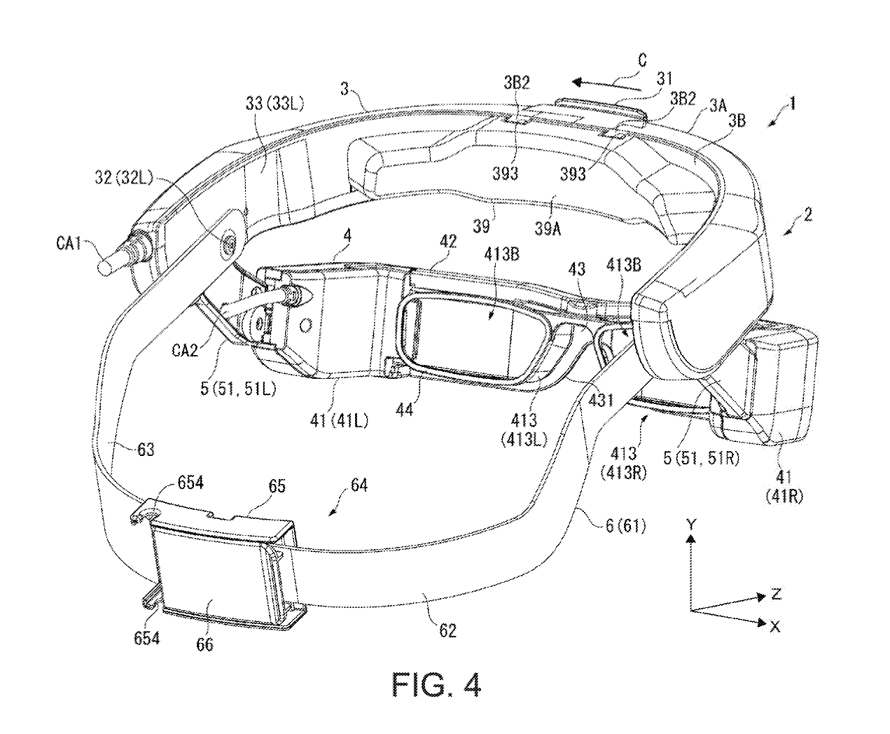

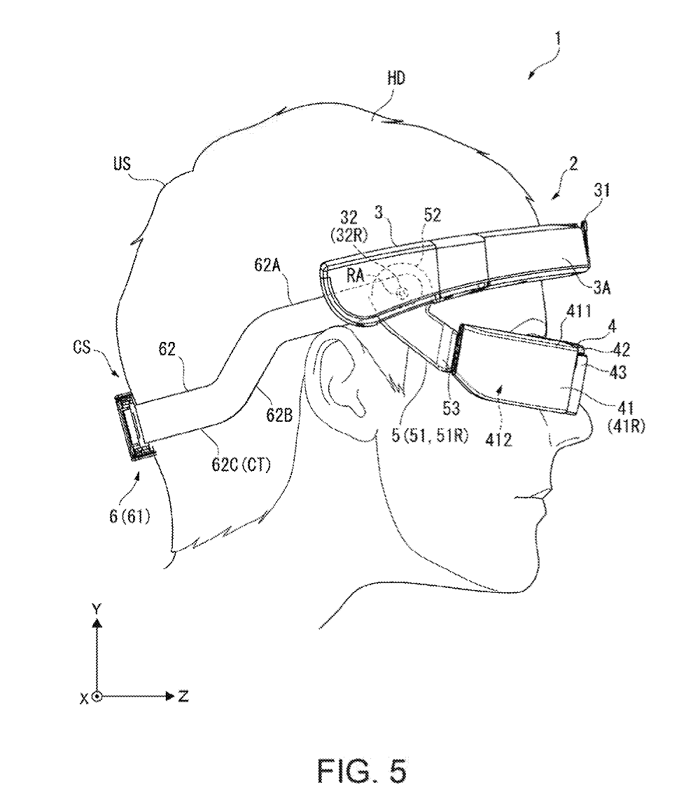

FIGS. 3 to 5 are diagrams illustrating the image display device 1. Specifically, FIG. 3 is a perspective view when the image display device 1 is seen from the left front side, and FIG. 4 is a perspective view when the image display device 1 is seen from the right back side. In addition, FIG. 5 is a right side view illustrating the image display device 1.

As shown in FIGS. 1 to 5, the image display device 1 includes a device main body 2 as a main body of a device mounted on the head, and a mounting member 6, and the device main body 2 includes a head band portion 3, a display portion 4 and a support member 5.

### Configuration of Head Band Portion

The head band portion 3 is equivalent to a frame according to the invention, and is a region for holding the head HD together with the mounting member 6 described later and mounting the image display device 1 on the head HD. As shown in FIGS. 1 to 5, this head band portion 3 is disposed in accordance with a position from the forehead of the head HD to the upper portion of the ear (a region corresponding to the forehead of the user US to a region corresponding to the upper portion of the ear in the cap CP, a helmet or the like, in a case where the cap, a helmet or the like is mounted on the head HD). Although not shown, this head band portion 3 has a substantially semicircular arc shape along the direction C when seen from the Y-direction side, and has an arc shape extending to an opposite side to the Y-direction gently toward an opposite side to the Z-direction when seen from the X-direction side. In other words, the head band portion 3 has a substantially U-shaped arc shape along the forehead and temporal region of the head HD when seen from the Y-direction side.

As shown in FIG. 3, an imaging portion 31 of which the imaging direction is directed to the Z-direction side is provided at the substantially central portion of a surface 3A on the Z-direction side in the head band portion 3, that is, the substantially central portion having an arc shape so as to be rotatable about a rotating shaft along the X-direction.

In addition, although not shown, a control portion including a control circuit that controls an operation of the image display device 1 is provided within the head band portion 3. One end of a cable CA1 extending out from the end of the head band portion 3 on the opposite side to the X-direction is connected to this control portion, and the other end of the cable CA is connected to an external device such as a control device, an image supply device or the like. Further, the control portion is connected to each optical device 41 (41L and 41R) constituting the display portion 4 through a cable CA2 (FIG. 4) which is wired within the head band portion 3 and the support member 5.

Such a control portion outputs image information, for example, received through the cable CA1, to each optical device 41 through the cable CA2, and also outputs a captured image which is input from the imaging portion 31 to an external device through the cable CA1.

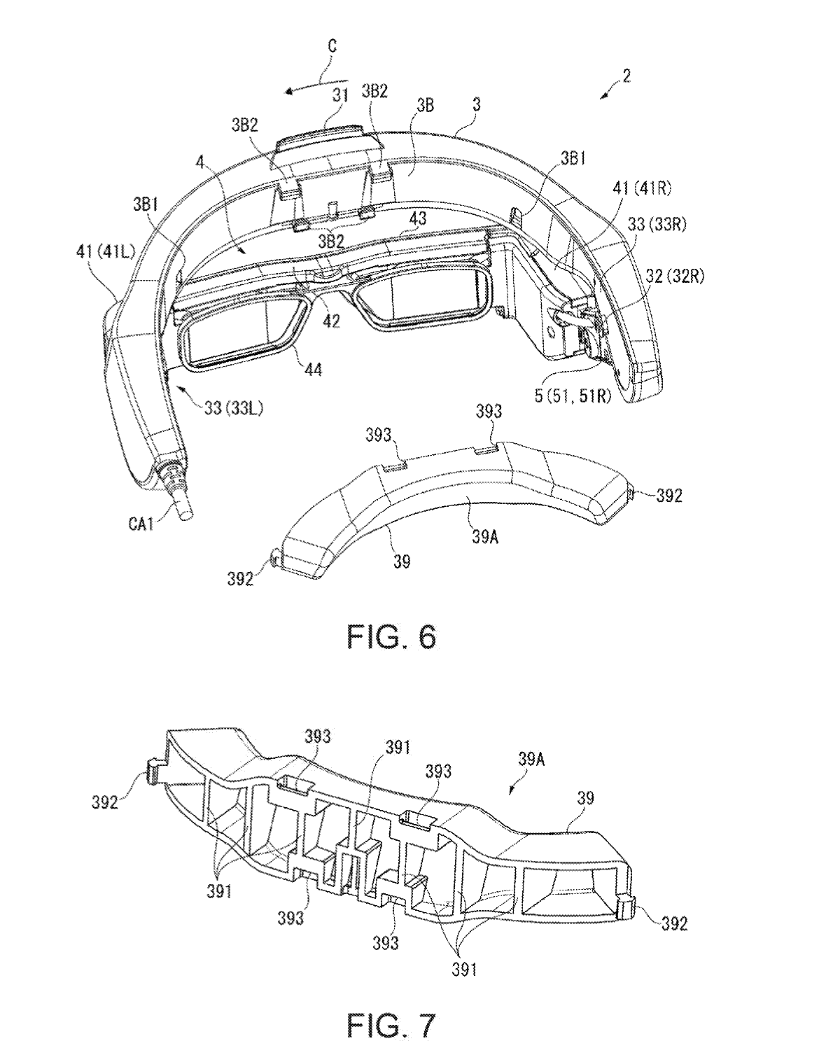

FIG. 6 is a perspective view when the head band portion 3 is seen from the back side, in other words, an exploded perspective view illustrating the head band portion 3 and a pad 39. In addition, FIG. 7 is a perspective view when the pad 39 is seen from a side facing the head band portion 3.

As shown in FIGS. 4 and 6, the head band portion 3 includes the pad 39 which is detachably installed at the center of a surface 3B on the opposite side to the Z-direction (surface 3B facing the head HD). This pad 39 comes into contact with the forehead when the image display device 1 is mounted on the head HD, and holds the head HD together with the mounting member 6 described later.

Such a pad 39 is an elastic member having an arc shape along the surface 3B, and is formed of rubber or a synthetic resin in the embodiment. As shown in FIG. 7, this pad 39 has a plurality of ribs 391 for securing a strength formed therein, and is also configured such that the inside thereof is formed to be hollow and is capable of being deformed moderately elastically.

In addition, the pad 39 includes protruding portions 392, inserted into hole portions 3B1 (FIG. 6) disposed on the surface 3B, on both ends, and also includes a plurality of recessed portions 393, into which hook-like fitting portions 3B2 (FIG. 6) disposed on the surface 3B are inserted, at the substantially central portion. The pad 39 is detachably installed on the head band portion 3 by these components.

Further, a surface 39A facing the head HD in the pad 39 is curved horizontally (in the X-direction) in accordance with the forehead, and is also curved vertically (in the Y-direction). Specifically, in a case where the image display device 1 is mounted on the head HD, the surface 39A is disposed so as to be directed to the user US side and to be directed downward.

Multiple types of pads having a dimension (width dimension) in the X-direction and a dimension (thickness dimension) in the Z-direction which are different from each other are prepared as such a pad 39, and the user US selects a pad 39 appropriate to the shape and size of his/her own head HD and installs the selected pad 39 on the head band portion 3. Thereby, it is possible to further improve the mountability of the image display device 1.

Such multiple types of pads 39 include a surface-treated pad, having a tendency for liquid such as sweat to flow, on a surface facing the head HD, and also include a pad having holes formed on the surface and having an absorptive member disposed in an internal space. By using these pads, it is possible to prevent the mounted image display device 1 from slipping due to liquid such as sweat, and to reduce a sense of discomfort due to the intervention of the liquid.

Referring back to FIGS. 3 to 5, in the head band portion 3, a pair of arms 51 (51L and 51R) constituting the support member 5 that supports the display portion 4 described later are rotatably installed at positions in the vicinity of both ends of the head band portion 3 having an arc shape, that is, positions in the vicinity of both ends in the direction C. Specifically, as shown in FIG. 5, the respective arms 51 have shafts 32, provided at positions biased slightly to the center from both ends of the head band portion 3 in the direction C (a shaft on the right side (X-direction side) for the user US is set to 32R, and a shaft on the left side (opposite side to the X-direction) is set to 32L), inserted thereinto, and are installed on the head band portion 3 so as to be rotatable about a rotating shaft RA which is determined by the shaft 32. This rotating shaft RA is a shaft along the X-direction, in other words, a shaft along the lineup direction of both eyes when the image display device 1 is mounted on the head HD.

These shafts 32L and 32R are disposed closer to the front side (Z-direction side) than the central position of the head HD in the Z-direction when the image display device 1 is mounted on the head HD. Specifically, these shafts 32L and 32R are disposed in accordance with the positions of the temples in the head HD, respectively.

In addition, the shafts 32L and 32R protrude to the surface 3B side through the inside of the head band portion 3, and bands 62 and 63 of the mounting member 6 described later are rotatably installed at protruding regions from the surface 3B, respectively. The pair of arms 51 and the mounting member 6 which are pivotally supported by these shafts 32L and 32R will be described later in detail.

Meanwhile, regions around the shafts 32L and 32R in the head band portion 3 are formed to have recessed portions 33 recessed to the opposite side to the user US (a recessed portion around the shaft 32L is set to 33L, and a recessed portion around the shaft 32R is set to 33R). Therefore, it is possible to increase a dimension between the shafts 32L and 32R and the head HD, and the shafts 32L and 32R are thereby prevented from coming into contact with the head HD.

### Configuration of Display Portion

The display portion 4 forms an image according to the image information which is input through the control portion, and causes the user US to visually recognize the image. Specifically, the display portion 4 guides the formed image to the left eye and the right eye of the user, using a light guide member 413 disposed in accordance with the left eye and the right eye, and causes the user to visually recognize the image as a virtual image. As shown in FIGS. 3 to 5, this display portion 4 includes two optical devices 41, a holding member 42, a cover member 43, and a lens holder 44.

### Configuration of Optical Device

The two optical devices 41 are constituted by a left-eye optical device 41L located on the left side (opposite side to the X-direction) of the user US and a right-eye optical device 41R located on the right side (X-direction side) when the image display device 1 is mounted, and have a relationship of being mirror-symmetrical with respect to each other. Each of these optical devices 41L and 41R includes a housing 411, an optical unit 412 and the light guide member 413.

The housing 411 has the optical unit 412 housed inside.

Although not shown specifically, the optical unit 412 includes a light source device, a light modulation device and a projection optical device, and modulates light emitted from the light source device using the light modulation device to emit the modulated light (image light according to the image information) to the light guide member 413 using the projection optical device. Meanwhile, the light modulation device capable of being adopted includes, for example, a device using a micromirror such as a micro electro mechanical system (MEMS) mirror, in addition to a liquid crystal panel.

The light guide members 413 (light guide members of the left-eye optical device 41L and the right-eye optical device 41R are set to 413L and 413R, respectively) are disposed at positions corresponding to the left eye and the right eye of the user US, and cause image light incident from the corresponding optical unit 412 to be incident on the eyes of the user US. A semi-transmissive layer (semi-reflective layer) is formed inside these light guide members 413 in accordance with pupil positions of the eyes of the user US. The user US can observe the external field through the semi-transmissive layer, and can also visually recognize an image of the image light which passes through the light guide members 413 and is reflected from the semi-transmissive layer. A surface 413A on the Z-direction side (surface 413A on the opposite side to the user US side) and a surface 413B on the opposite side to the Z-direction (surface 413B on the user US side) in these light guide members 413 are plane surfaces substantially parallel to each other.

Meanwhile, the light guide member 413 is mainly formed of a resin (for example, cycloolefin polymer) showing a high light-transmissive property in a visible light region.

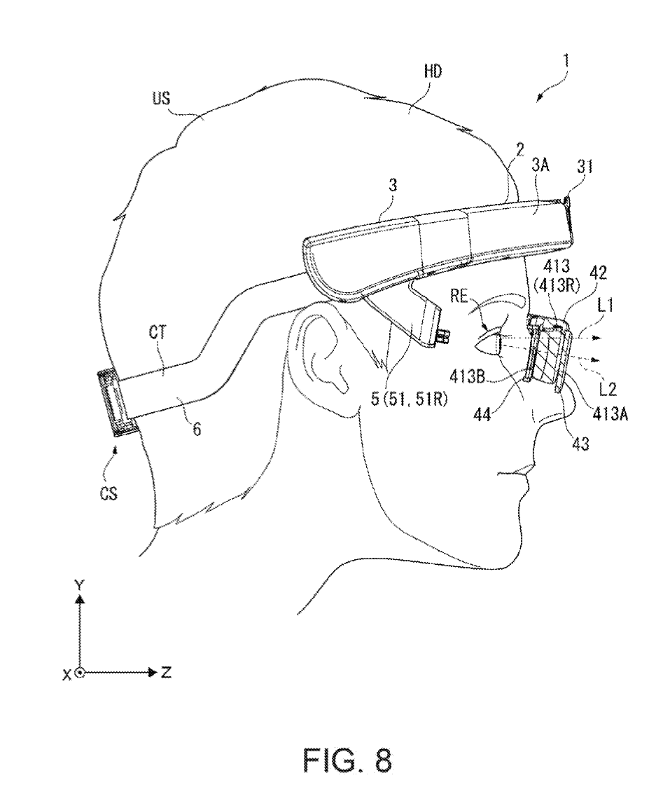

FIG. 8 is a diagram illustrating an arrangement position of the light guide member 413 (413R) with respect to the line of sight. Meanwhile, the direction of the line of sight of the right eye RE of the user US is shown in FIG. 8.

In a case where the user US faces the line of sight in a predetermined direction, each of the light guide members 413 is disposed so that a virtual image plane which is reflected from the semi-transmissive layer of the light guide member 413 and is visually recognized is substantially at right angles to the line of sight. Specifically, when the line of sight in a case where the line of sight is directed along the Z-direction (in a case where the line of sight is along a horizontal direction in a state where the axial direction of the head HD is along a vertical direction) is set to L1, the light guide member 413 is disposed so that the respective surfaces 413A and 413B are substantially at right angles to each other in a line of sight L2 inclined downward at substantially 10° with respect to the line of sight L1. Thereby, the virtual image plane is substantially at right angles to the line of sight L2.

Generally, in a case where the axial direction of the head HD is along a vertical direction, a person feels more comfortable when the line of sight is directed slightly downward than when the line of sight is extended along a horizontal direction. Specifically, in a case where the line of sight is extended along the horizontal direction in the arrangement state of the head HD, the extraocular muscles changing the line of sight are required to be more strained than in a case where the line of sight is directed more slightly downward than in the horizontal direction, and thus the extraocular muscles has a tendency to be fatigued. Conversely, in a case where the line of sight is directed more slightly downward than in the horizontal direction in the arrangement state of the head HD, the extraocular muscles are less strained than in a case where the line of sight is along the horizontal direction, and thus is not likely to be fatigued. Therefore, in a state of being relaxed in a standing posture, the line of sight is directed substantially 10° downward with respect to the horizontal direction, and in a state of being relaxed in a seated posture, the line of sight is directed substantially 150 with respect to the horizontal direction.

In regard to this, the light guide member 413 is disposed at the above position, and thus it is possible to visually recognize an image (virtual image) in a state of being relaxed in a standing posture. Therefore, it is possible to reduce fatigue when the user US wearing the image display device 1 performs a predetermined work while observing an image in a standing posture.

Meanwhile, although described later in detail, each of the arms 51 that supports the display portion 4 is vertically rotatable about the shaft 32, and the display portion 4 is also vertically slidable with respect to the arm 51. Therefore, it is possible to adjust the position of the display portion 4 (particularly, light guide member 413) in accordance with the direction of line of sight and the position of the eye.

### Configuration of Holding Member

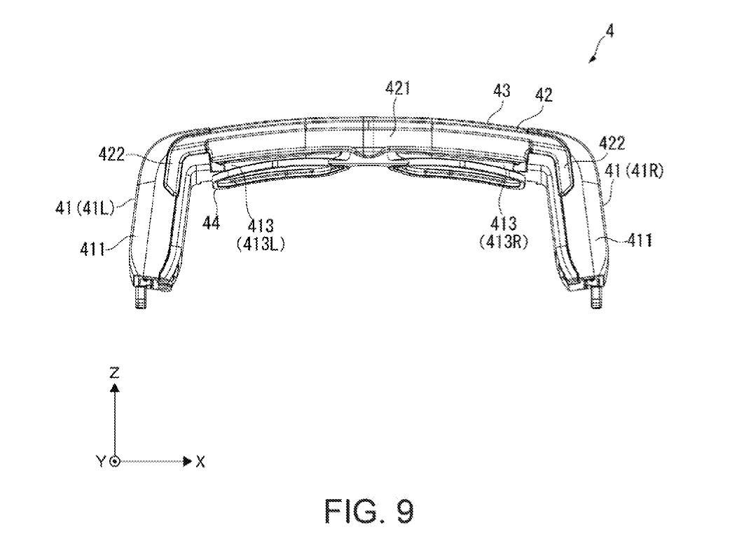

FIG. 9 is a plan view when the display portion 4 is seen from the Y-direction side.

The holding member 42 holds each optical device 41, the cover member 43 and the lens holder 44. As shown in FIG. 9, this holding member 42 includes a first holding portion 421 along the X-direction and a pair of second holding portions 422 extending out from both ends of the first holding portion 421, respectively, in an opposite direction to the Z-direction, and is formed in a substantially U-shape when seen from the Y-direction side.

A housing 411 of the left-eye optical device 41L is fixed to a second holding portion 422 of the pair of second holding portions 422 on the left side (opposite side in the X-direction) of the user US, and a housing 411 of the right-eye optical device 41R is fixed to a second holding portion 422 on the right side. Each of these housings 411 is installed on the tip of a corresponding arm 51 (end on the tip side in an extending direction from the head band portion 3, and end on the Z-direction side) so as to be slidable along the Y-direction.

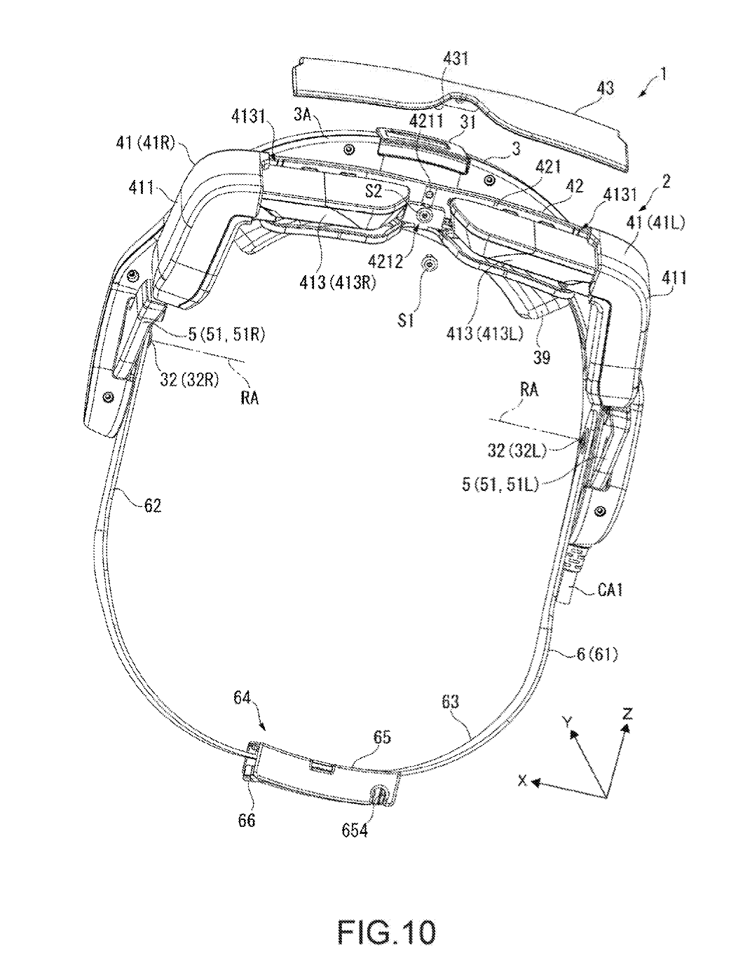

Each light guide member 413 of the optical devices 41L and 41R is installed on the first holding portion 421. In addition, in the first holding portion 421, screw holes 4211 and 4212 (see FIG. 10) are formed in a region corresponding to between these light guide members 413, the screw holes being used for fixing the cover member 43 and the lens holder 44 to the region.

### Configuration of Cover Member

FIG. 10 is a perspective view illustrating the image display device 1 having the cover member 43 removed therefrom.

As shown in FIG. 10, the cover member 43 covers the respective light guide members 413 (413L and 413R) installed on the holding member 42 on the Z-direction side and protect the light guide members. This cover member 43 is installed on the first holding portion 421 by a screw S1 which is threadedly engaged with the screw hole 4211.

Such a cover member 43 is formed in a substantially rectangular plate shape of which the substantially central portion in the X-direction is curved to the Z-direction side when seen from the Z-direction side, and includes a recessed portion 431 having a substantially inverse U shape at a position corresponding to the nose of the head HD.

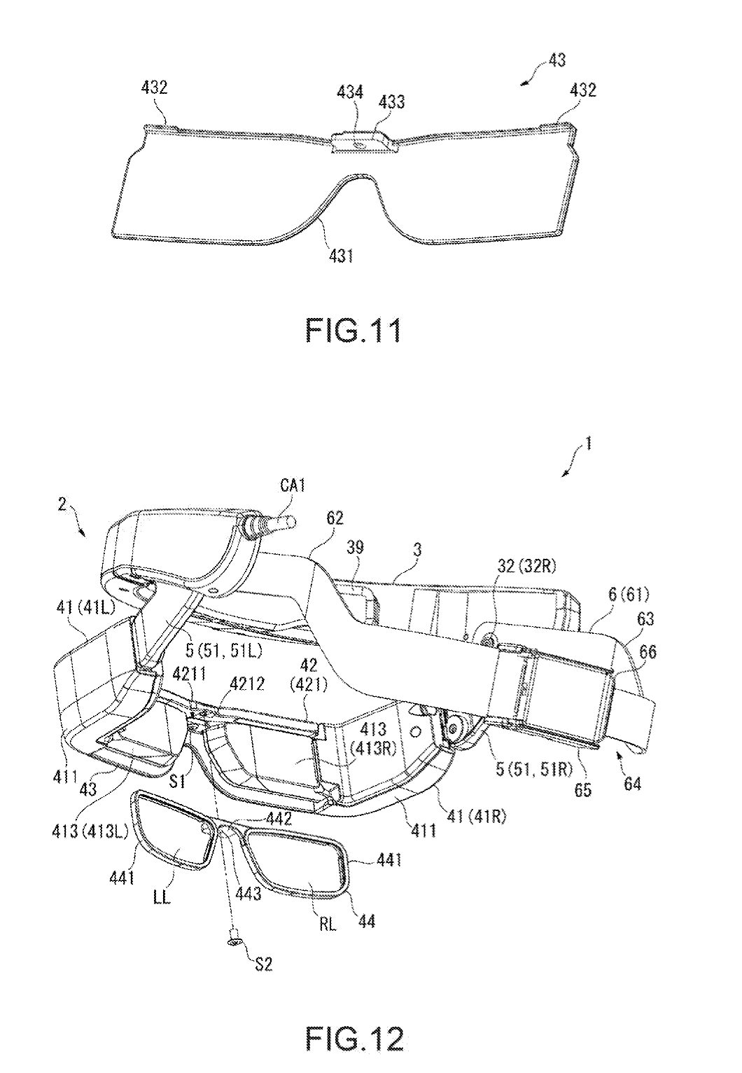

FIG. 11 is a perspective view when the cover member 43 is seen from a side facing the light guide member 413.

As shown in FIG. 11, the cover member 43 includes a pair of protruding portions 432 and a fixed portion 433 on a surface facing the light guide member 413.

The pair of protruding portions 432 are protrusively provided on one end side (opposite side to the recessed portion 431 side) in the short-side direction of the cover member 43 and both ends on the long-side direction thereof (X-direction when the image display device 1 is mounted on the head HD). One protruding portion 432 of the pair of protruding portions 432 is inserted into a recessed portion 4131 formed at a position on the opposite side to the X-direction in the light guide member 413L, and the other protruding portion 432 is inserted into the recessed portion 4131 formed at a position on the X-direction side in the light guide member 413R. Thereby, the cover member 43 is positioned with respect to each of the light guide members 413L and 413R.

The fixed portion 433 is protrusively provided on a substantially central portion in the long-side direction on the ends where the pair of protruding portions 432 are located. This fixed portion 433 includes a through-hole 434 passing through the fixed portion 433 along the short-side direction. The screw S1 inserted into the through-hole 434 is threadedly engaged with the screw hole 4211, and thus the cover member 43 is fixed to the holding member 42 (first holding portion 421).

Multiple types of such cover members 43 having different light transmittances are prepared. For example, a cover member 43 having a low light transmittance is installed, and thus the external light does not reach the eye. Thereby, the light and darkness of an image which is visually recognized become obvious, and the visibility of the image is improved. In addition, for example, a cover member 43 having a high light transmittance is installed, and thus the visibility of the external field through the light guide member 413 and the cover member 43 is secured.

### Configuration of Lens Holder

FIG. 12 is a perspective view illustrating the image display device 1 having the lens holder 44 removed therefrom.

The lens holder 44 is used for holding vision correction lenses LL and RL, and functions like spectacles. This lens holder 44 includes a pair of fitting portions 441 to which the left-eye lens LL and the right-eye lens RL are respectively fitted. Besides, the lens holder 44 includes a fixed portion 442 which is located at a bridge portion for connecting the pair of fitting portions 441.

A insertion hole 443 into which a screw S2 is inserted is formed in the fixed portion 442, and the screw S2 is threadedly engaged with the screw hole 4212. Thereby, the lens holder 44 is detachably installed on the holding member 42 (first holding portion 421).

### Configuration of Support Member

As shown in FIGS. 3 and 4, the support member 5 is rotatably installed on the head band portion 3, and supports the display portion 4, to thereby connect the head band portion 3 and the display portion 4. This support member 5 includes the pair of arms 51, and the pair of arms 51 is constituted by the arm 51R for connecting the shaft 32R to the housing 411 of the right-eye optical device 41R, and the arm 51L for connecting the shaft 32L to the housing 411 of the left-eye optical device 41L. As shown in FIG. 5, each of these arms 51L and 51R includes a first end 52 and a second end 53.

In the following description, the first end 52 and the second end 53 of the arm 51R will be described, but the same is true of the first end 52 and the second end 53 of the arm 51L.

The first end 52 is pivotally supported by the shaft 32 within the head band portion 3. Thereby, the arm 51 can be rotated about the rotating shaft RA which is determined by the shaft 32.

The second end 53 is a portion which is connected to the housing 411. Although not shown specifically, this second end 53 is provided with a slide mechanism capable of sliding the connected housing 411 along the Y-direction. Thereby, the user US can position the light guide member 413 at a position where an image is easily seen by sliding the display portion 4.

With the configurations of these arms 51, each of the arms 51 is upward rotated about the rotating shaft RA, thereby allowing the display portion 4 (light guide member 413) to be located at a position where an image is not visually recognized. Meanwhile, as described above, the respective shafts 32 (32L and 32R) are disposed at positions corresponding to the temples in the head band portion 3 when the image display device 1 is mounted on the head HD. Therefore, even in a case where the arms 51 are rotated, the arms 51 are prevented from hitting the ears.

### Configuration of Mounting Member

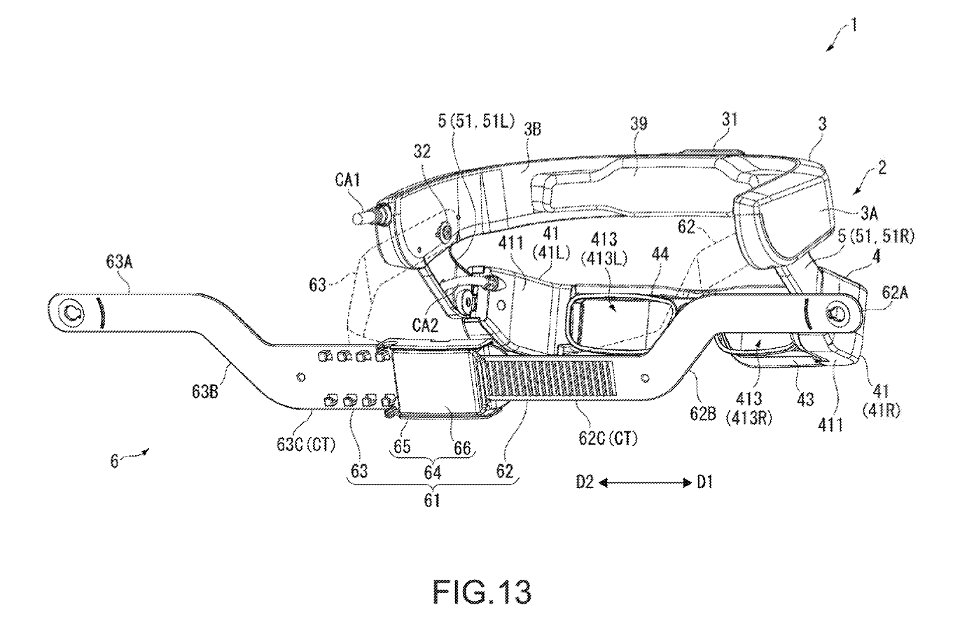

FIG. 13 is a perspective view illustrating the back side (opposite side to the Z-direction) of the image display device 1.

The mounting member 6 is used for holding the head HD together with the pad 39 and mounting the image display device 1 on the head HD. As shown in FIG. 13, this mounting member 6 includes one mounting band 61 having the first band 62 and the second band 63 combined by a regulation mechanism 64, and these bands 62 and 63 are vertically rotatably installed on the respective corresponding shafts 32R and 32L.

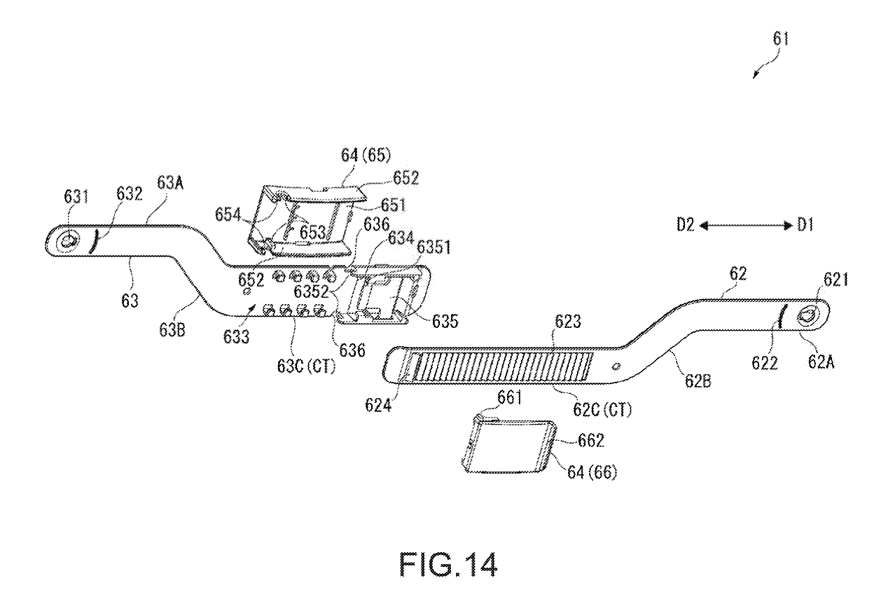

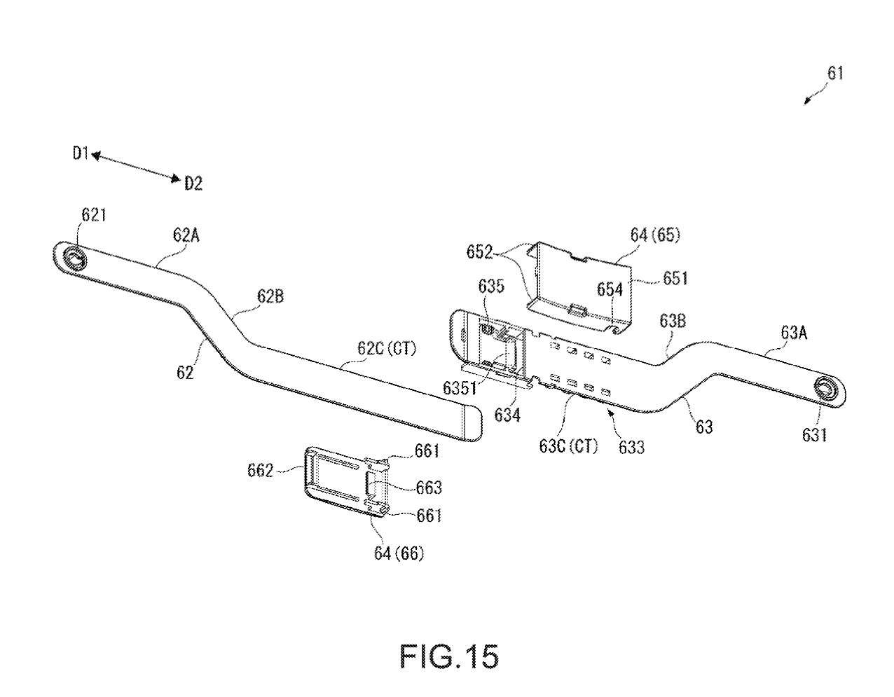

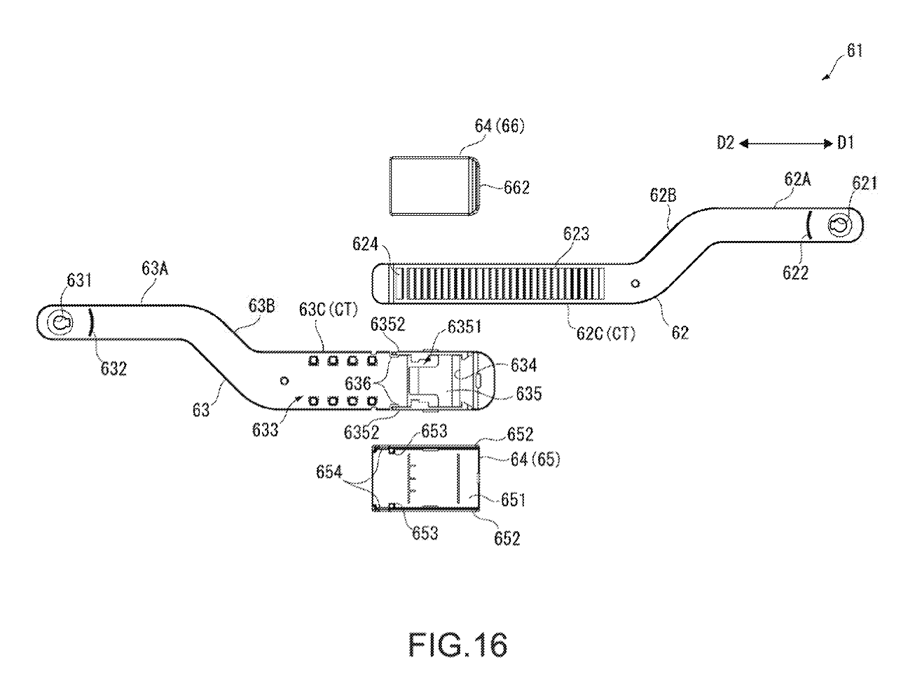

FIGS. 14 and 15 are exploded perspective views illustrating the mounting band 61. Specifically, FIG. 14 is an exploded perspective view when seen from the back side (opposite side to the head HD side), and FIG. 15 is an exploded perspective view when seen from the front side (head HD side). In addition, FIG. 16 is a plan view in which each configuration of the mounting band 61 is exploded.

The first band 62 is a band, formed of a synthetic resin, which has predetermined flexibility and hardness. This first band 62 has one end rotatably installed on the shaft 32R (see FIG. 3), and is disposed in the right temporal region and the occipital region of the user US. As shown in FIGS. 14 to 16, such a first band 62 is formed in a substantially S shape in a lateral direction, and includes a first extending portion 62A linearly extending out from the shaft 32R, a second extending portion 62B obliquely extending out from the first extending portion 62A, and a third extending portion 62C extending out from the tip of the second extending portion 62B in parallel with the first extending portion 62A and in a direction separating from the first extending portion 62A. When the first band 62 is disposed along the head HD, as shown in FIG. 5, the first extending portion 62A extends out along the arc-shaped extended line of the head band portion 3, the second extending portion 62B extends out downward from the first extending portion 62A, and the third extending portion 62C is disposed in a contact region CS which is set in a lower portion in the occipital region. The width dimension (vertical dimension) of the third extending portion 62C out of these extending portions 62A, 62B, and 62C which comes into contact with the contact region CS is larger than each width dimension of the first extending portion 62A and the second extending portion 62B.

Meanwhile, the lower portion in which the contact region CS is set in the occipital region indicates a region from a region protruding most backward up to the nape of the neck in the occipital region. In the present embodiment, the contact region CS is set in a region including the external occipital protuberance. However, without being limited thereto, the contact region CS may be any region insofar as the contact region is set in the lower region such as, for example, a region including a hollow at the nape of the neck.

As shown in FIGS. 14 and 16, such a first band 62 includes a fitting hole 621, a contact portion 622, an engagement portion 623 and a regulation portion 624.

The fitting hole 621 and the contact portion 622 are located at the first extending portion 62A. The fitting hole 621 is a region into which the shaft 32R is inserted. The contact portion 622 protrudes in a substantially arc shape from the plane surface of the first extending portion 62A, and reduces sliding resistance when the first band 62 comes into contact with the surface 3B of the head band portion 3.

The engagement portion 623 and the regulation portion 624 are located at the third extending portion 62C. The engagement portion 623 is provided with a plurality of teeth having a cross-sectionally saw-toothed shape, and is locked by a locking portion 635 of the second band 63 described later. The regulation portion 624 is located closer to the vicinity of the end on the opposite side to the first extending portion 62A side in the third extending portion 62C than the engagement portion 623. This regulation portion 624 is constituted by one tooth larger than one tooth of the engagement portion 623.

Similarly to the first band 62, the second band 63 is a band, formed of a synthetic resin, which has predetermined flexibility and hardness. This second band 63 has one end rotatably installed on the shaft 32L (see FIG. 4), and is disposed along the left temporal region and the occipital region of the user US. As shown in FIGS. 14 to 16, such a second band 63 is formed in a substantially S shape in a lateral direction, and includes a first extending portion 63A linearly extending out from the shaft 32L, a second extending portion 63B obliquely extending out from the first extending portion 63A, and a third extending portion 63C extending out from the tip of the second extending portion 63B in parallel with the first extending portion 63A and in a direction separating from the first extending portion 63A.

Meanwhile, the direction of intersection of the second extending portion 63B with the first extending portion 63A and the third extending portion 63C is an opposite direction to the direction of intersection of the second extending portion 62B with the first extending portion 62A and the third extending portion 62C in the first band 62. When the second band 63 is disposed along the head HD, although not shown, similarly to the first band 62, the first extending portion 63A extends out along the arc-shaped extended line of the head band portion 3, the second extending portion 63B extends out downward from the first extending portion 63A, and the third extending portion 63C is disposed in the contact region CS. Similarly to the first band 62, the width dimension (vertical dimension) of the third extending portion 63C out of these extending portions 63A, 63B, and 63C which comes into contact with the contact region CS is larger than each width dimension of the first extending portion 63A and the second extending portion 63B.

That is, the third extending portion 62C of the first band 62 and the third extending portion 63C of the second band 63 are combined with each other, to thereby constitute a contact portion CT that comes into contact with the contact region CS in the mounting band 61.

Such a second band 63 includes a fitting hole 631, a contact portion 632, a pressing portion 633, an opening 634, a locking portion 635, and two recessed portions 636.

Similarly to the first band 62, the fitting hole 631 and the contact portion 632 are located at the first extending portion 63A. The fitting hole 631 is a region into which the shaft 32L is inserted. The contact portion 632 is a region that protrudes in a substantially arc shape from the plane surface of the first extending portion 63A, and reduces sliding resistance when the second band 63 comes into contact with the surface 3B of the head band portion 3.

The pressing portion 633, the opening 634, the locking portion 635 and the two recessed portions 636 are disposed in the third extending portion 63C. Specifically, the pressing portion 633 is located on the second extending portion 63B side in the third extending portion 63C, and the opening 634 and the locking portion 635 are located on the opposite side to the second extending portion 63B side, that is, the tip side of the third extending portion 63C.

As shown in FIG. 15, the opening 634 is formed in a substantially rectangular shape.

The locking portion 635 is disposed so as to cover a portion of the opening 634. This locking portion 635 is engaged with one tooth out of a plurality of teeth included in the engagement portion 623, and includes a locking claw 6351 that locks the engagement portion 623 and the first band 62.

The tip portion of the third extending portion 62C of the first band 62 is inserted into a region of the third extending portion 63C on the tip side in the opening 634. This tip portion is further inserted into a region on the second extending portion 63B side in the opening 634. For this reason, a portion of the first band 62 is exposed to the support member 65 side, described later, in the second band 63. In this state, the locking claw 6351 is engaged with the teeth of the engagement portion 623, and thus the first band 62 is locked to the second band 63.

Meanwhile, although not shown, the region located closer to the second extending portion 63B side than the locking claw 6351 in the first band 62 is pressed against the second band 63 side by the pressing portion 633 located on the second extending portion 63B side in the third extending portion 63C.

In addition, hook-shaped portions 6352 protruding to the second extending portion 63B side are vertically formed at the end on the second extending portion 63B side in the locking portion 635. In addition, recessed portions 636 are vertically formed at positions corresponding to the respective hook-shaped portions 6352 in the third extending portion 63C. The hook-shaped portions 6352 and the recessed portions 636 are used when a pressing piece 66 of the regulation mechanism 64 is rotatably supported.

As shown in FIGS. 14 to 16, the regulation mechanism 64 can adjust the length dimension of the mounting band 61. Specifically, the regulation mechanism 64 can regulate the relative position of the first band 62 with respect to the second band 63. This regulation mechanism 64 is constituted by each component located at the third extending portions 62C and 63C, the support member 65 located on the second band 63 side, and the pressing piece 66, located on the first band 62 side, which is rotatably supported by the support member 65.

The support member 65 includes a substantially rectangular curved portion 651 conforming to the shape of the contact region CS and a pair of side portions 652 protruding from the upper and lower end edges, respectively, in the curved portion 651, and is formed in a substantially lateral U shape when seen from the lateral side. As shown in FIGS. 14 to 16, ribs 653 having a substantially rectangular parallelepiped shape are formed in intersection regions between the curved portion 651 and the respective side portions 652 in the inner surface of this support member 65.

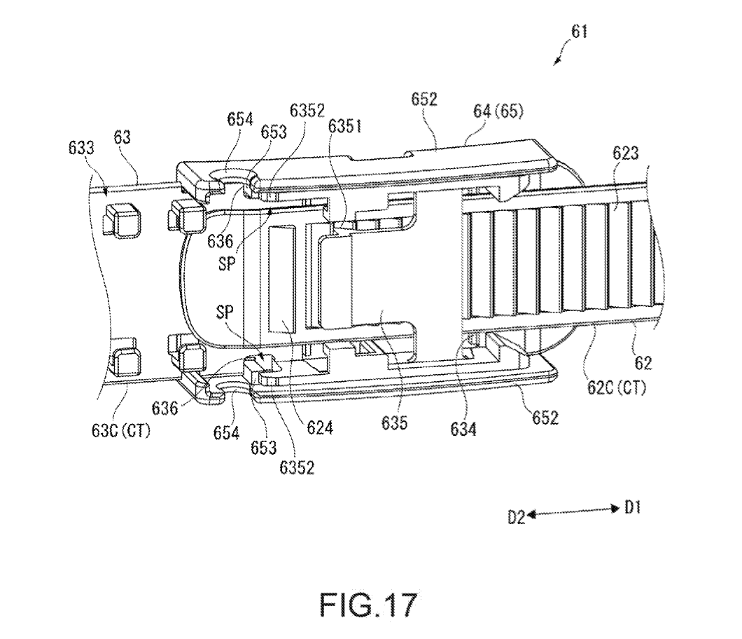

FIG. 17 is a perspective view illustrating the state of engagement of the support member 65 with the first band 62 and the second band 63 in the mounting band 61.

As shown in FIG. 17, when the support member 65 and the second band 63 are combined with each other, these ribs 653 are disposed within recessed portions 638 of the second band 63, respectively. Spaces SP are formed between the respective ribs 653 and the hook-shaped portions 6352 corresponding thereto. Shafts 661, described later, in the pressing piece 66 are disposed within these spaces SP. Thereby, the pressing piece 66 is rotatably supported with respect to the support member 65.

In addition, as shown in FIGS. 14 to 17, the support member 65 includes a holding portion 654 on one end side in each of the pair of side portions 652, that is, the end on the second extending portion 63B side when the support member 65 and the second band 63 are combined with each other. That is, the holding portion 654 is located on the arrangement side of the cable CA1 in the support member 65. The holding portion 654 is a recessed portion which is open to the pressing piece 66 side, and the holding portion 654 holds the cable CA1 by the cable CA1 being fitted. Thereby, when the image display device 1 is mounted on the head HD, it is possible to suppress the movement of the cable CA1.

As shown in FIGS. 14 to 16, the pressing piece 66 is an integral molding, made of a synthetic resin, which is formed in a substantially rectangular plate shape. This pressing piece 66 rotates with respect to the support member 65 to thereby press the locking claw 6351 toward the engagement portion 623, locks the first band 62, and also functions as a release portion that separates the locking claw 6351 from the engagement portion 623 to thereby release the locked state of the first band 62 due to the locking claw 6351. As shown in FIGS. 14 and 15, the pressing piece 66 includes two shafts 661, a finger hooking portion 662 and a pressing portion 663.

The two shafts 661 are located on one end side (second extending portion 63B side of the second band 63) in the pressing piece 66, and protrude upward and downward, respectively. These shafts 661 are disposed within the spaces SP, and thus the pressing piece 66 is rotatably installed on the support member 65. Meanwhile, the cross-sectional shape of the shaft 661 is an elliptical shape, and the plane portion in the shaft 661 comes into contact with the lateral side of the rib 653.

The finger hooking portion 662 is located on the other end side in the pressing piece 66, and is curved on the opposite side to the support member 65. This finger hooking portion 662 is a portion for the user US easily hooking a finger when the pressing piece 66 supported by the support member 65 is rotated.

As shown in FIG. 15, the pressing portion 663 is protrusively provided at a position held by the two shafts 661 on a surface on the side facing each of the bands 62 and 63 and the support member 65. This pressing portion 663 presses the locking claw 6351 toward the engagement portion 623 by the pressing piece 66 being rotated about the shaft 661 so as to be along each of the bands 62 and 63. Thereby, the locking claw 6351 is engaged with the engagement portion 623, and thus the first band 62 is locked. On the other hand, when the pressing piece 66 is rotated in a direction in which the finger hooking portion 662 is separated from each of the bands 62 and 63, the pressing of the locking claw 6351 by the pressing portion 663 is released. In this state, the locking of the first band 62 is released, and thus the first band 62 is made slidable in a long-side direction with respect to the second band 63. Meanwhile, the pressing portion 663 is provided at a position on the shaft 661 side (position of the pressing piece 66 on the rotating shaft side) in the pressing piece 66, but may be provided at other positions insofar as the locking claw 6351 can be pressed.

### Length Adjustment of Mounting Band

As described above, the mounting band 61 is configured by the first band 62, the second band 63, and the regulation mechanism 64 being combined with each other. In this mounting band 61, when the pressing piece 66 is rotated in a direction in which the finger hooking portion 662 is separated from the support member 65, the state of engagement of the locking claw 6351 with the engagement portion 623 is released as described above. Thereby, the first band 62 is made slidable with respect to the second band 63, in a direction D1 in which the length dimension of the mounting band 61 increases and a direction D2 in which the length dimension thereof decreases.

As shown in FIG. 5, in a state where the first extending portions 62A and 63A and the second extending portions 62B and 63B are extended along the temporal region, and the third extending portions 62C and 63C are extended along the contact region CS, when the length dimension of the mounting band 61 is adjusted and the pressing piece 66 is rotated in an opposite direction to the above, the pressing portion 663 of the pressing piece 66 presses the locking claw 6351, and the locking claw 6351 is engaged with the teeth of the engagement portion 623. Thereby, the length dimension of the mounting band 61 is maintained by the first band 62 being locked to the second band 63, and the device main body 2 including the head band portion 3 having the mounting band 61 installed thereon is mounted on the head HD.

In this state, the contact portion CT which is constituted by the third extending portions 62C and 63C faces the surface 39A of the pad 39 to be in substantially parallel thereto, and thus a holding force based thereon can be caused to stably act on the head HD. Therefore, the image display device 1 can be stably mounted on the head HD.

Meanwhile, in a case where the first band 62 slides greatly in the direction D1 with respect to the second band 63, the regulation portion 624 comes into contact with the locking claw 6351. As described above, since this regulation portion 624 is formed to be larger than one tooth of the engagement portion 623, the locking claw 6351 is not able to surmount the regulation portion 624 simply by the movement of the first band 62 in the direction D1. Therefore, it is possible to prevent the first band 62 from falling out of the second band 63, and to prevent the image display device 1 from unexpectedly falling off from the head HD.

### Effects of Embodiment

According to the image display device 1 of the present embodiment described above, the following effects are exhibited.

The head HD is held by the head band portion 3 coming into contact with the forehead of the user US and the mounting band 61 coming into contact with the contact region CS in the vicinity of the external occipital protuberance, and thus the image display device 1 is mounted on the head HD. According to this, it is possible to hold the head HD at positions located on opposite sides of each other in the head HD. Therefore, it is possible to stably mount the image display device 1 on the head HD, as compared to a configuration in which an image display device is mounted so as to be placed on the ears and the nose by temple portions and a nose pad member. Therefore, it is possible to improve the mountability of the image display device 1.

The head band portion 3 is formed in an arc shape conforming to the shape of the forehead in the vicinity of the head HD. In addition, the mounting band 61 includes the first extending portions 62A and 63A, connected to the head band portion 3, which extend out along the respective arc-shaped extended lines of the head band portion 3, the second extending portions 62B and 63B extending out downward from the respective first extending portions 62A and 63A, and the third extending portions 62C and 63C, extending out from the respective second extending portions 62B and 63B in parallel with the respective first extending portions 62A and 63A, which constitute the contact portion CT coming into contact with the contact region CS. According to this, the ears are caused not to be covered with the mounting band 61 which is connected to the head band portion 3 located above the ears, and thus it is possible to bring the contact portion CT in the mounting band 61 into contact with the contact region CS. Therefore, it is possible to improve the mountability of the image display device 1.

Each of the first extending portions 62A and 63A is connected to the head band portion 3 so as to be rotatable about the rotating shaft RA which is parallel to the lineup direction of both eyes of the user US. According to this, the mounting band 61 is vertically rotatable about the rotating shaft RA, and thus it is possible to rotate the mounting band 61 so that the contact portion CT comes into contact with the contact region CS, in accordance with the size or shape of the head HD. Therefore, it is possible to mount the image display device 1 at an appropriate position, and to further improve the mountability of the image display device 1.

The shafts 32 (32L and 32R) for determining the rotating shaft RA are located in the vicinity of both ends having an arc shape in the head band portion 3 and on the surface 3B facing the head HD. According to this, since the mounting band 61 is installed in the vicinity of both ends having an arc shape in the head band portion 3, it is possible to easily bend each of the bands 62 and 63 having predetermined flexibility and hardness, and to easily extend the mounting band 61 along the head HD. Besides, since the mounting band 61 is connected to the surface 3B, it is possible to easily extend the mounting band 61 along the head HD, as compared to a case of being connected to the surface 3A on the opposite side to the surface 3B. Therefore, it is possible to further improve the mountability of the image display device 1.

The arms 51L and 51R that support the display portion 4 are rotatably installed on the head band portion 3. According to this, by rotating these arms 51L and 51R, it is possible to locate the display portion 4 at a position appropriate to the user US, and to locate the display portion 4 outside of the visual field of the user US. Therefore, it is possible to locate the display portion 4 at a desired position of the user US.

The respective rotating shafts of the arm 51R and the first extending portion 62A are coaxially located, and the respective rotating shafts of the arm 51L and the first extending portion 63A are coaxially located. Specifically, the arm 51R and the first extending portion 62A are rotatably supported by the shaft 32R, and the arm 51L and the first extending portion 63A are rotatably supported by the shaft 32L. According to this, the shafts 32R and 32L by which the arms 51R and 51L are respectively pivotally supported can be used as shafts for pivotally supporting the respective first extending portions 62A and 63A. For this reason, it is not necessary to separately provide shafts for installing these first extending portions 62A and 63A. Therefore, it is possible to prevent the configurations of the head band portion 3 and the image display device 1 from being complicated.

The width dimension (vertical dimension) of the contact portion CT which is constituted by the third extending portions 62C and 63C overlapping each other is larger than the width dimension of each of the first extending portions 62A and 63A and the second extending portions 62B and 63B. According to this, it is possible to easily bend the first extending portions 62A and 63A and the second extending portions 62B and 63B which are located along the temporal region, and to easily extend the mounting band 61 along the temporal region. In addition, since the area of contact with the contact region CS can be made larger, it is possible to stably bring the contact portion CT into contact with the contact region CS. Therefore, it is possible to further improve the mountability of the image display device 1.

The mounting band 61 includes the regulation mechanism 64 capable of adjusting the length of the mounting band 61. According to this, it is possible to adjust the length dimension of the mounting band 61 in accordance with the shape and size of the head HD of the user US, and thereby, each user US can appropriately wear the image display device 1.

The first band 62 is moved relatively to the second band 63, and then the first band 62 is locked by the pressing piece 66 and the locking portion 635 constituting the regulation mechanism 64, thereby allowing the adjusted length of the mounting band 61 to be maintained. In addition, since the locked state of the first band 62 by the locking portion 635 can be released by rotating the pressing piece 66 as a release portion, it is possible to extend the mounting band 61 to such an extent that the image display device 1 can be detached from the head HD. Therefore, it is possible to reliably perform the attachment and detachment of the image display device 1 to and from the head HD.

When the first band 62 slides greatly in the direction D1 with respect to the second band 63, the regulation portion 624 constituting the regulation mechanism 64 comes into contact with the locking portion 635 constituting the regulation mechanism 64 likewise. According to this, it is possible to regulate the falling off of the first band 62 from the second band 63. Therefore, it is possible to prevent the image display device 1 from falling off from the head HD due to the first band 62 falling off from the second band 63 unintentionally, when the locked state of the first band 62 is released.

The device main body 2 includes the cable CA1 extending out from the head band portion 3 to the outside, and the regulation mechanism 64 includes the holding portion 654 that holds the cable CA1. According to this, even when the user US wearing the image display device 1 carries out a predetermined work, it is possible to suppress a fluctuation of the cable CA1 extending out from the head band portion 3. Therefore, it is possible to improve the convenience of the image display device 1.

The head band portion 3 is provided with the pad 39 as an elastic member which comes into contact with the forehead of the user US. According to this, by the pad 39 being elastically deformed, it is possible to further improve the mounting feeling of the image display device 1 as compared to a case where a relatively solid portion in the head band portion 3 comes into direct contact with the forehead. In addition, it is possible to hold the head HD in a front-rear direction while applying an appropriate pressure to the head HD through the pad 39 and the mounting band 61 which are elastically deformed during the mounting of the image display device 1. Therefore, it is possible to further improve the mountability of the image display device 1.

The pad 39 is formed to be hollow. According to this, it is possible to facilitate the elastic deformation of the pad 39 coming into contact with the forehead during the mounting of the image display device 1 on the head HD. Therefore, it is possible to still further improve the mountability of the image display device 1.

### Modification of Embodiment

The invention is not limited to the above-mentioned embodiment, but changes, modifications and the like within the range capable of achieving the object of the invention are included in the invention.

In the above embodiment, the head band portion 3 as a frame is formed in an arc shape conforming to the shape of the head HD (specifically, forehead). However, the invention is not limited thereto. For example, the head band portion 3 may be formed in a substantially rectangular parallelepiped shape. In this case, a surface facing the head HD may be formed in an arc shape conforming to the shape of the head HD. That is, the head band portion 3 may be formed in any shape. In addition, in the invention, the frame is not limited to a configuration in which the frame is disposed in accordance with the forehead, and may have a configuration in which the frame is disposed in the temporal region (for example, position located above the ear).

In the above embodiment, the mounting band 61 includes the first band 62 and the second band 63, and these bands 62 and 63 include the first extending portions 62A and 63A and the second extending portions 62B and 63B that intersect each other away from the ears of the user US. However, the invention is not limited thereto. That is, each of the bands 62 and 63 may be a linear band having no inclined portion, and the mounting band 61 may be constituted by one band. In this case, the regulation mechanism may be able to regulate the length of the mounting band by bending the bands, overlapping the bands, or the like, and may be configured as a mounting member having no regulation mechanism. In addition, for example, the mounting member may be configured to be formed in a substantially annular shape in which a portion thereof is cut out by a plurality of bands (arms) formed in an arc shape, and to be mounted on the head HD by outward extending at least a position of one band of the plurality of bands in accordance with the shape and size of the head HD.

In addition, the mounting member 6 (mounting band 61) may be formed of, for example, a material (such as a synthetic resin) by which such hardness as to be capable of maintaining a state where the mounting member 6 is disposed along the head HD can be obtained by the mounting member 6, and may be formed of other materials.

In the above embodiment, the first extending portions 62A and 63A of the respective bands 62 and 63 located on both ends of the mounting band 61 are rotatably connected to the shafts 32R and 32L for determining the rotating shaft RA located along the X-direction which is the lineup direction of both eyes. However, the invention is not limited thereto. That is, insofar as the mounting band 61 can be vertically rotatably connected, the mounting band may not be connected to the shafts 32R and 32L which protrude to the surface 3B on the user US side and extend out along the X-direction. For example, the mounting band may be connected to both ends of the head band portion 3, and may be connected to the surface 3A on the opposite side to the user US in the head band portion 3.

In the above embodiment, the support member 5, installed on the head band portion 3, which supports the display portion 4 includes the pair of arms 51 (51L and 51R). However, the invention is not limited thereto. For example, the support member may be configured to include one arm. The mounting position of the arm in the head band portion 3 in this case may be the center of the head band portion 3 in the direction C, or may be one end side thereof. Further, the arm 51 may not be able to be rotated, and may be fixed to the head band portion 3.

In addition, these arms 51 are installed so as to be rotatable about the shafts 32 (32L and 32R) having the mounting band 61 installed thereon. However, the invention is not limited thereto. That is, the arm 51 and the band rotating shaft of the mounting band 61 may not be coaxially located, and the shaft having the arm 51 installed thereon and the shaft having the mounting band 61 installed thereon may be different from each other.

Further, the display portion 4 is provided in the head band portion 3 through the support member 5, but the invention is not limited thereto. For example, the display portion 4 may be configured to be directly provided in the head band portion 3 as a frame. In addition, even in a case where the display portion 4 is configured to be provided in the head band portion 3 through the support member, the configuration of the support member does not matter.

In the above embodiment, in the first band 62 and the second band 63, the third extending portions 62C and 63C are larger in width dimension than the first extending portions 62A and 63A and the second extending portions 62B and 62C. In other words, the vertical dimension in the contact portion CT coming into contact with the contact region CS of the user US in the mounting band 61 is larger than the vertical dimension in a region corresponding to the temporal region. However, the invention is not limited thereto. For example, the mounting band 61 may be a mounting band having a uniform dimension in the width direction, and the width dimension of the contact portion CT may be made smaller than the width dimensions of other regions.

In the above embodiment, the regulation mechanism 64 is configured to be capable of slide the first band 62 with respect to the second band 63, to engage the locking claw 6351 with the engagement portion 623 of the first band 62 in a state where the length dimension of the mounting band 61 is adjusted, and to thereby lock the first band 62. However, the invention is not limited thereto. For example, instead of the regulation mechanism 64, a regulation mechanism may be adopted which regulates the length dimension of the mounting band by winding a string-like member suspended on each shaft 32 in association with the rotation of a dial or the like. In this case, the position of the dial is not limited to the vicinity of the contact region CS, and may be located at a position corresponding to the temporal region.

In the above embodiment, the first band 62 is provided with the regulation portion 624 that regulates falling out from the second band 63 including the locking portion 635. However, the invention is not limited thereto. That is, insofar as the falling out of the first band 62 can be regulated, the regulation portion may be provided so as to have any configuration, and the configuration of the regulation portion itself can also be changed. For example, the regulation portion may be provided in either of the support member 65 and the pressing piece 66 combined with each other.

In the above embodiment, the support member 65 constituting the regulation mechanism 64 includes the holding portion 654 that holds the cable CA1. However, the invention is not limited thereto. For example, the holding portion 654 may not be included therein. In addition, the holding portion 654 may have a hook-like shape without being limited to the recessed portion into which the cable CA1 is fitted.

In addition, the device main body 2 (control portion within the head band portion 3) and the external device (such as a control device or an image supply device) are connected to each other through the cable CA1 extending out from the head band portion 3 to the outside. That is, the device main body 2 and the external device are wiredly connected to each other. However, the invention is not limited thereto. That is, the control portion of the image display device 1 and the external device may be wirelessly connected to each other insofar as communication connection can be made therebetween. In this case, for example, the control portion may include a wireless communication module, and the wireless communication module may be disposed in a region (for example, the display portion 4 or the support member 5) different from the control portion.

In the above embodiment, the pad 39 which is an elastic member coming into contact with the forehead is detachably provided on the surface 3B facing the head HD in the head band portion 3. However, the invention is not limited thereto. For example, such a pad 39 may not be included, or the pad 39 may be fixed to the surface 3B.

In addition, the pad 39 may be formed to be solid without being formed to be hollow. Further, the pad 39 may be a cushion formed of a foam material or the like such as, for example, urethane without being limited to rubber.

In the above embodiment, the mounting band 61 of the mounting member 6 is configured to be rotatably and detachably installed on the head band portion 3 in two places of the shafts 32R and 32L. However, the invention is not limited thereto. For example, the mounting member 6 may be installed in, for example, one place located at the center on the surface 3B. In addition, the mounting band 61 may not necessarily be rotatable with respect to the head band portion 3, and may be fixed to the head band portion 3.

In the above embodiment, in the head band portion 3, the recessed portion 33 is formed in the vicinity of the shaft 32. However, the invention is not limited thereto. For example, the recessed portion 33 may not be included. In this case, the curvature of the head band portion 3 may be set so that a space of such an extent that the shaft 32 does not come into contact with the head HD is formed between the surface 3B of the head band portion 3 and the head HD.

In the above embodiment, the mounting member 6 includes the belt-like mounting band 61 provided with the first band 62, the second band 63 and the regulation mechanism 64. However, the invention is not limited thereto. That is, the mounting member 6 may have other shapes insofar as the mounting member comes into contact with the contact region CS and can hold the head HD together with the head band portion 3. For example, the mounting member 6 may include a cap-like covering portion that covers the head HD, in addition to the mounting band 61. In addition, the mounting member 6 may be a string-like member having a cross-sectionally cylindrical shape, a rectangular cylindrical shape or the like, and may be configured such that a surface facing the head is plane, and that surfaces other than the surface have a curved surface shape such as an arc shape.

In the above embodiment, the display portion 4 is configured to include the left-eye optical device 41L and the right-eye optical device 41R. However, the invention is not limited thereto. That is, the display portion may be configured to include only one of these optical devices 41L and 41R. In this case, a configuration in which the optical device is supported by one arm, for example, a configuration in which the left-eye optical device 41L is supported by only the left arm 51L may be used, and a configuration in which the optical device is supported by a plurality of arms 51 may be used.

In the above embodiment, each of the light guide members 413L and 413R is fixed to the holding member 42. However, the invention is not limited thereto. For example, the light guide members 413L and 413R may be configured to be rotatable about the rotating shaft along the X-direction on the opposite side to the head HD side, independently of or in conjunction with each other. In this case, the rotating shaft is configured to be located on the Y-direction side or the opposite side to the Y-direction in the light guide member 413, and thus light guide member 413 can be retreated from the visual direction of the user US by the rotation thereof.

In the above embodiment, the head band portion 3 includes the imaging portion 31 provided so as to be rotatable about the rotating shaft which is parallel to the X-direction. However, the invention is not limited thereto. That is, the imaging portion 31 may not be included, may be provided so as to be rotatable about the rotating shaft located along other directions, or may be fixed thereto.

In the above embodiment, the control portion is provided within the head band portion 3. However, the invention is not limited thereto. For example, the control portion may be provided within the display portion 4 (for example, within the housing 411) or the arm 51.

In the above embodiment, the image display device 1 is configured as a see-through HMD capable of observing the external field through the light guide member 413, in addition to be capable of visually recognizing an image as a virtual image. However, the invention is not limited thereto. That is, the invention can also be applied to a non-transmission-type HMD which is not capable of observing the outside world, or a video see-through HMD that displays an image captured by an imaging element that captures an image of the outside world.

In the above embodiment, the image display device 1 is configured as a virtual image display device that displays an image which is visually recognized as a virtual image by the user US. However, the invention is not limited thereto. The invention can be applied insofar as a device that causes the user to visually recognize an image is used. For example, a configuration may be adopted in which a display portion such as a liquid crystal panel or an organic electro-luminescence (EL) panel is disposed at positions corresponding to both eyes of the user. That is, the light guide member 413 is not essential.

In addition, the invention can also be applied to a laser retinal projection-type HMD. For example, the invention may be applied to an HMD in which the display portion includes a laser light source and an optical system that guides a laser light source to a user's eyes, and causes a user to visually recognize an image by causing laser light to be incident on a user's eyes to scan the retina, and forming an image on the retina.

The entire disclosure of Japanese Patent Application No. 2015-123642, filed Jun. 19, 2015 is expressly incorporated by reference herein.

What is claimed is:

1. An image display device comprising:
a display portion that displays an image so as to be capable of being observed by a user;
a frame that comes into contact with the forehead in the head of the user; and
a mounting member, formed of a material having a predetermined hardness, which comes into contact with a contact region which is set in a lower portion in the occipital region of the head and holds the head together with the frame.

2. The image display device according to claim 1, wherein the mounting member is connected to the frame so as to be rotatable about a rotating shaft parallel to a lineup direction of both eyes of the user.

3. The image display device according to claim 2, wherein the frame is formed in an arc shape conforming to a shape of the head,
the rotating shaft includes a first rotating shaft and a second rotating shaft to which the mounting member is rotatably connected, and
the first rotating shaft and the second rotating shaft are located on one end side and the other end side having the arc shape in the frame, and on a surface facing the head.

4. The image display device according to claim 3, further comprising a support member, rotatably installed on the frame, which supports the display portion.

5. The image display device according to claim 4, wherein the support member includes a pair of arms which are rotatably connected to a shaft provided on in the vicinity of both ends having the arc shape in the frame,
a rotating shaft of one arm out of the pair of arms is located coaxially with one rotating shaft out of the first rotating shaft and the second rotating shaft, and
a rotating shaft of the other arm is located coaxially with the other rotating shaft out of the first rotating shaft and the second rotating shaft.

6. The image display device according to claim 1, wherein the frame is formed in an arc shape conforming to a shape of the head, and
the mounting member includes
a pair of first extending portions, connected to the frame, which extend out along an arc-shaped extended line of the frame,
a pair of second extending portions that extend out downward from the pair of first extending portions, respectively, and
a contact portion that extends out from each of the pair of second extending portions in parallel with an extending direction of the pair of first extending portions, and comes into contact with the contact region.

7. The image display device according to claim 6, wherein the contact portion is larger in vertical dimension than each of the pair of first extending portions and each of the pair of second extending portions.

8. The image display device according to claim 6, wherein the mounting member includes a regulation mechanism capable of regulating a length of the mounting member.

9. The image display device according to claim 8, wherein the mounting member includes
a first band including one first extending portion out of the pair of first extending portions, one second extending portion out of the pair of second extending portions which is connected to the one first extending portion, and a portion of the contact portion, and
a second band including the other first extending portion out of the pair of first extending portions, the other second extending portion out of the pair of second extending portions, and another portion of the contact portion,
the regulation mechanism is provided in the one band so as to be capable of sliding one band out of the first band and the second band relatively to the other band, and
the regulation mechanism includes
a locking portion that locks one band out of the first band and the second band with respect to the other band, and
a release portion that releases a locked state of the one band by the locking portion.

10. The image display device according to claim 9, wherein the regulation mechanism includes a regulation portion that regulates falling off of one of the first band and the second band from the other band.

11. The image display device according to claim 8, wherein the frame includes a cable extending out from the frame to an outside, and
the regulation mechanism includes a holding portion that holds the cable.

12. The image display device according to claim 6, wherein the frame includes an elastic member, provided in the frame, which comes into contact with the forehead.

13. The image display device according to claim 12, wherein the elastic member is formed to be hollow.
